(19) United States
(12) Patent Application Publication
(10) Pub. No.: US 2010/0150405 A1
(43) Pub. Date: Jun. 17, 2010

(54) SYSTEM AND METHOD FOR DIAGNOSIS OF HUMAN BEHAVIOR BASED ON EXTERNAL BODY MARKERS

(76) Inventor: Nader Butto, Petach Tikva (IL)

Correspondence Address: DR. D. GRAESER LTD., 9003 FLORIN WAY, UPPER MARLBORO, MD, 20772, US

(21) Appl. No.: 12/515,952

(22) PCT Filed: Nov. 22, 2007
(86) PCT No.: PCT/IL07/01444

§ 371 Date: Feb. 24, 2010

Related U.S. Application Data
(60) Provisional application No. 60/919,920, filed on Mar. 26, 2007.

(30) Foreign Application Priority Data
Nov. 22, 2006 (IL) 179507

(51) Int. Cl. G06K 9/00

(52) U.S. Cl. 382/117; 382/118

(57) ABSTRACT

A system and a method for identifying an individual's human code and uses thereof.

### FIELD OF THE INVENTION

The present invention relates to a system and a method for providing observations and diagnoses of an individual based on external body markers, and in particular, for such a system and method that determines individual characteristics, personality traits, state of health, mental health or abilities by uncovering and mapping the individual's human code.

### BACKGROUND OF THE INVENTION

Facial recognition and image analysis is well known for its use in security applications such as travel and airports security. Other applications for face recognition involve biometric means for identifying a person. However, currently face recognition software does not provide a system or method for abstracting more information from the facial characteristics beyond the biometric and security information. That is, although a face may identified and geometrically defined much like fingerprint, this information does not relay details about the actual person. More specifically, the prior art does not teach a method and system that can diagnose an individual based on the facial characteristics and information obtained. Such information may be utilized by both traditional and conventional medicine to offer further insight into the person behind the face.

### SUMMARY OF THE INVENTION

There is an unmet need for, and it would be highly useful to have, a system and a method for diagnosing and identifying the state of health of an individual based on external markers such as that of body and/or facial characteristics.

The present invention overcomes these deficiencies of the background by providing a system and method for identifying and diagnosing an individual based on external markers related to the body, preferably including markers related to the face. Preferably, the diagnosis is accomplished by determining a unique human code that is abstracted from the body and/or facial characteristics of an individual.

The human code is a code that is able to characterize an individual. The human code is a means for integrating conventional medicine with traditional medical practices, for example including but not limited to Chinese medicine, Indian medicine or the like.

Conventional medicine attempts to diagnose and predict health problems in an individual based on observations and data by a healthcare provider trained in a particular field of medicine, usually corresponding to a particular organ or organ system. For example, a psychologist is trained to identify problems related to the mind, a cardiologist is a specialist of the heart and cardiovascular system, while a dental surgeon specializes in the health of teeth and the oral cavity. However, conventional medicine does not offer or rarely offers an integrative view of the body as a whole linking body, mind and soul.

Conversely, traditional medicine practices come in various forms such as acupuncture, homeopathic medicine, Chinese medicine, and Indian medicine. Each form of traditional healing respectfully offers an explanation or observation of an individual from a different perspective, yet all relate to a holistic view of the individual.

An optional embodiment of the present invention provides a system and method that unifies both traditional and conventional healing systems via a human code. More specifically, the human code is specific to an individual and optionally and preferably is used to diagnose that individual in a comprehensive manner. Optionally, the universal code may be obtained in a reversible manner from the human code or vise versa. Optionally, the universal code depicts the energy state of an individual or system under study, that may optionally be related to an individual's general state of health. The human code is preferably abstracted based on at least one or more parameters. Optionally, the parameters used to abstract the human code comprise personal data including but not limited to subject's name, date of birth and the subject's maternal name or the like. Preferably at least one or more parameters used to abstract an individual's human code is based on body and more preferably facial characteristics, which are most preferably obtained automatically, optionally using facial recognition software. Optionally, at least one or more parameters may be used to abstract an individual's human code following an analysis for example including but not limited to a personal interview, a questionnaire, or the like process. Optionally, the facial recognition parameters may be used in conjunction with analysis parameters obtained to abstract an individual's human code.

An optional embodiment of the present invention provides for a system and method for obtaining the human code of an individual by automatic means. For example, image processing and analysis methods and software are known in the art. Such image processing could optionally be used to analyze an image of an individual, preferably including at least the face of the individual, to abstract one or more parameters related to the human code. The human code could then optionally and preferably be calculated automatically from these abstracted parameters, optionally with a manual review and/or adjustment process.

Non-limiting examples of image processing methods which could optionally be implemented with the present invention include methods described in U.S. Pat. No. 6,301,370, for facial recognition; and U.S. Pat. No. 6,947,579, which performs three dimensional facial recognition; both of which are hereby incorporated by reference as if fully set forth herein. The method of U.S. Pat. No. 6,301,370 uses bunch graphs for representing facial features, which are abstracted from an image by using wavelet analysis. U.S. Pat. No. 6,947,579 performs three dimensional facial recognition by using a three dimensional scanner to obtain an image of a face (or other aspect of a person), and then analyzing the three dimensional image to determine one or more facial features.

An optional embodiment of the present invention provides for a system and method from obtaining a diagnosis of an individual utilizing his human code by semi-automatic means. For example, a software interface could optionally provide a plurality of questions, intended to elicit answers related to the parameters for the human code. Optionally, the person who is providing such answers would not need to know the significance of each answer for the parameter, but instead could provide information based upon viewing an individual and/or an image thereof Once the answers are provided, the human code may be calculated for the individual being diagnosed.

An optional embodiment of the present invention provides for a system and method from obtaining a diagnosis of an individual utilizing a personalized human code by telemetric means for example including but not limited to the Internet, markup language, or the like, for providing a software interface for implementing any of the above automatic or semi-automatic diagnostic methods. For example, a physician could be located at a remote location from a patient, but upon being provided with a scanned image of the patient, could still perform the diagnosis, whether automatically (through image analysis) or semi-automatically (by reviewing the image for the necessary parameters and then indicating the parameter values through the software interface). Additionally or alternatively, the above automatic or semi-automatic methods could be provided through a web (mark up language) interface, regardless of the relative location of the doctor and patient. A layperson could also optionally operate the software interface for self diagnosis.

A further optional embodiment of the present invention provides a system and method for converting or transforming the human code to other code forms for example including but not limited to the universal code. Optionally, the human code may be abstracted by a conversion or transformation from other codes optionally including but not limited to the universal code.

Optionally the system and method of the present invention in any of the embodiments may optionally be implemented over a network connection using wireless, cellular, optical, wired communication protocols, or the like.

Optionally the system and method of the present invention in any of the embodiments may optionally used as a self help system for private use using any type of computer for example including but not limited to a cellular telephone, PDA, personal computer and/or any other type of computer as defined herein.

Unless otherwise defined, all technical and scientific terms used herein have the same meaning as commonly understood by one of ordinary skill in the art to which this invention belongs. The materials, methods, and examples provided herein are illustrative only and not intended to be limiting. Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the present invention is described with regard to a “computer” optionally on a “computer network”, it should be noted that optionally any device featuring a data processor and/or the ability to execute one or more instructions may be described as a computer, including but not limited to a PC (personal computer), a server, a minicomputer, a cellular telephone, a smart phone, a PDA (personal data assistant), a pager. Any two or more of such devices in communication with each other, and/or any computer in communication with any other computer, may optionally comprise a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A-B are schematic diagrams of the notation format for the human code according to the present invention; and

FIG. 2A-C are schematic diagrams of various facial types analyzed by the system and method of the present invention; and

FIG. 3A-D are schematic diagrams of various facial types analyzed by the system and method of the present invention; and

FIG. 4A-B are schematic block diagrams of optional exemplary systems according to the present invention;

FIG. 5 is a flowchart of an exemplary method according to the present invention;

FIG. 6 is a schematic diagram of the facial analysis process according to an optional embodiment of the present invention; and

FIG. 7 is a table defining various facial parameters used to evaluate a face according to an optional embodiment of the present invention; and

FIG. 8 is a flowchart of an exemplary method for image processing according to the present invention.

### DESCRIPTION OF THE PREFERRED EMBODIMENTS

The present invention is of a system and a method for diagnosing individuals based on their human code according to a plurality of characteristics and or parameters of the individual. Preferably the system and method of the present invention provides for an automatic determination of the human code using image analysis algorithms, for example for analyzing to characteristics of the body, and more preferably by using facial recognition software.

The principles and operation of the present invention may be better understood with reference to the drawings and the accompanying description.

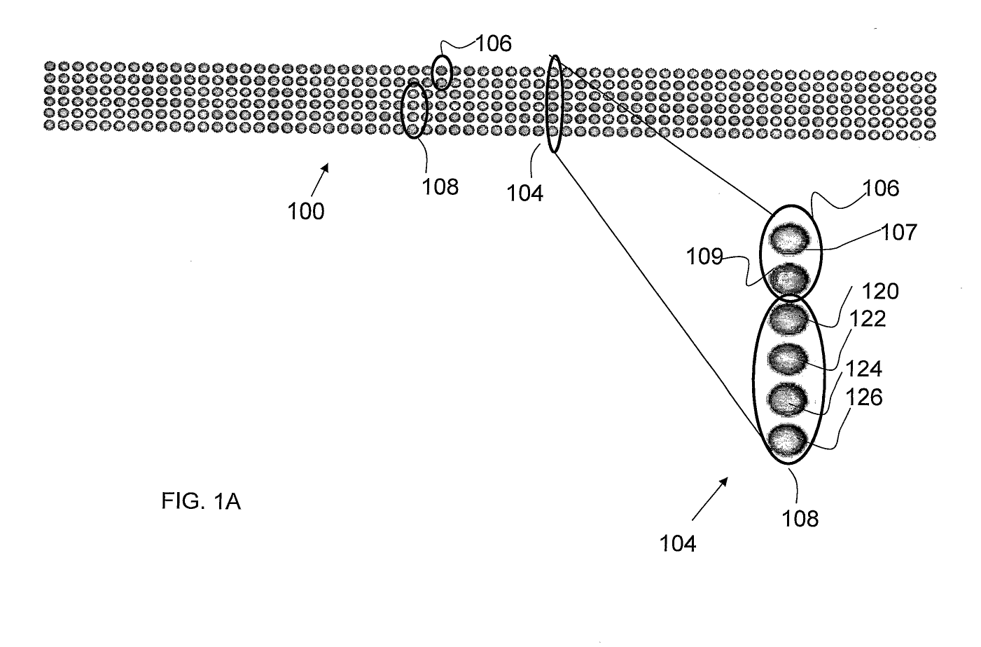

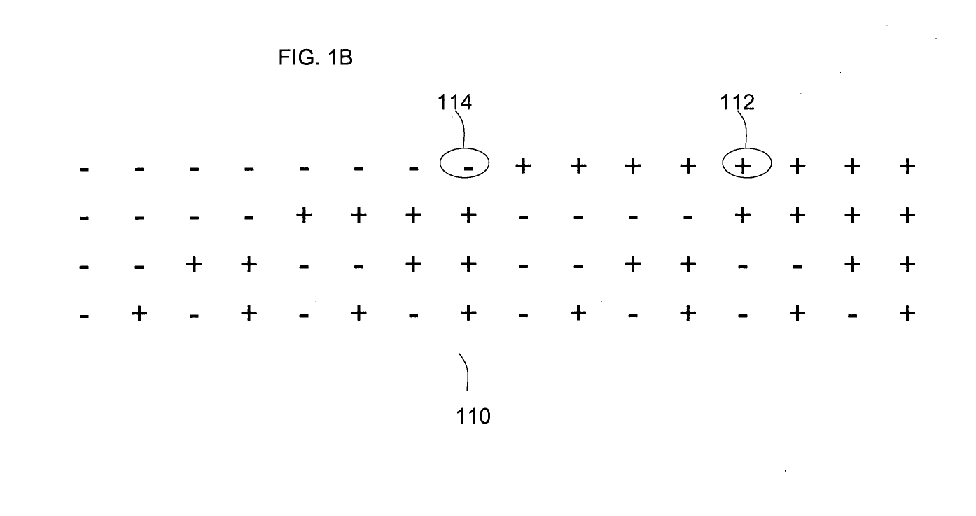

Referring now to the drawings, FIG. 1A is an illustrative schematic presentation of the human code 100. The human code contains 64 different columns 104 that represent a code defining a plurality of options for a system. Therefore each column 104 is different from each other column 104, and defines the different options available within a system under observation. Preferably, each column 104 is represented by 6 members which may optionally be of any type, for example including but not limited to colored objects, binary digits, or addition sign (+) or minus sign (−). Optionally and preferably the 6 members are composed of two or more groups of parameters. Optionally and preferably the upper two members 106 represent the polarity associated with an individual, while the lower four members 108, represent the elemental portion of the code comprising earth 126, air 122, water 124 and fire 120. Preferably, of the two members 106, the upper member 107 determines the dominant polarity of a subject. Therefore each position in the code is important.

Similarly code 100 may be a representation of the universal code instead of the human code, depending on the definition of the 6 members which compose this code. Where the human code is based on polarity and the scoring of the four elements, the universal code is dependent on an individual energy system for the subject being scored. Without wishing to be limited by a single hypothesis, it is believed that this energy system is initiated for the individual during fertilization.

For example, a facial recognition system according to an optional embodiment of the present invention may identify one of the 64 facial parameter combinations by scoring facial features. Optionally, the parameters or features may be graded and identified with a red circle, or with a blue circle. Therefore each column represents an optional parametric combination relative to a system under study.

FIG. 1B displays an alternative representation of the human code 110. Human code 110 depicts a representational system that is optionally marked with addition sign (+) 112 or a minus sign (−) 114. Optionally, representation of the human code may be undertaken by any means to indicate the value or code of a feature, for example including but not limited to color coded shapes, binary numbers, plus or minus signs and the like.

Optionally, the sign used to represent elemental features 108 preferably indicate the presence or absence of and elemental feature associated with a face. For example, an addition sign (+) indicates the presence of an element while a minus sign (−) indicates the absence of an element. Similarly, a certain colored shape for example red circle may indicate the presence of the element while a blue circle may indicate the absence of the element. Optionally, the polarity portion of the code is similarly represented, preferably indicating the type of polarity rather than presence or absence.

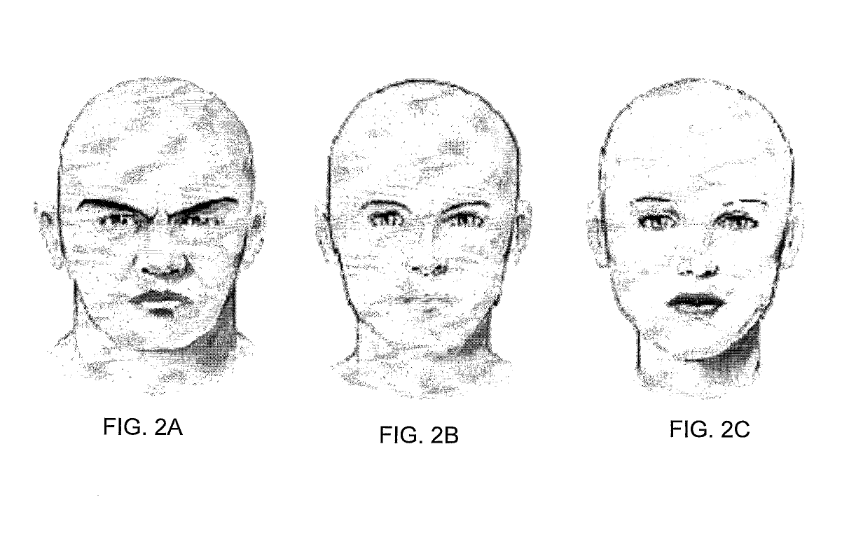

FIG. 2A-C depicts exemplary facial diagram of different polarity facial features that may be optionally and preferably used during the abstraction of the human code according to the present invention. FIG. 2A-C shows the scale of facial features that are optionally used to determine an individual's polarity which in turn is used to determine the individual's human code. As depicted in FIG. 1A, the top two members 106 of the 6 member human code are a representation of an individual's polarity. The polarity scale has two extremes, male (or rather masculine), as depicted in FIG. 2A, and female (or rather feminine), as depicted in FIG. 2C, as well as a number of fluid intermediates one of which is represented by FIG. 2B.

Optionally and preferably an individual's facial expression determines the polarity configuration. FIG. 2A represents facial features that represent predominantly male polarity, while FIG. 2C depicts facial features that represent predominantly female polarity. FIG. 2C depicts balanced facial features that corresponding to balanced polarity that are not predominantly male or female. The system and method according to an optional embodiment of the present invention preferably is able to automatically recognize such facial features in depicting the polarity portion of human code of the subject under study.

According to an optional embodiment of the present invention each of the faces presented by FIGS. 2A-2C would produce an individual human code specific to its facial features. According to an optional embodiment of the present invention the human code would optionally and preferably be utilized to abstract a diagnosis relative to the subject and face under study.

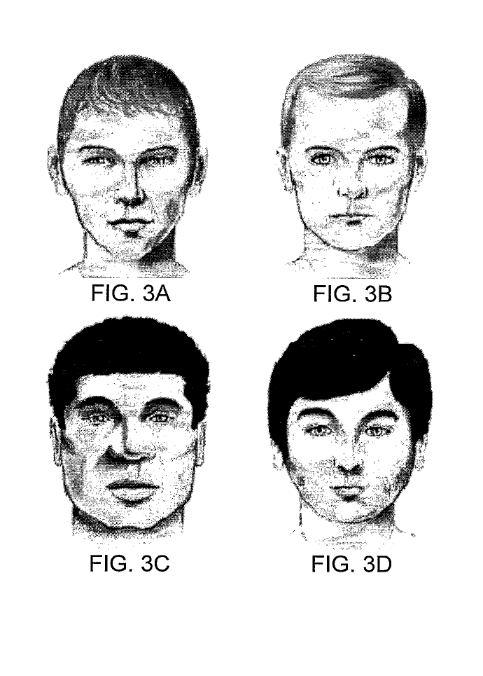

FIG. 3A-D depicts four different optional elemental features that are associated with a face. Preferably, the four elements are chosen from the group consisting of earth, air, fire, water. Optionally the system and method of the present invention will score various facial features in tetins of their likeness to one of the four elemental groups, optionally a threshold may be used to determine the absence or presence of an element. Optionally and preferably the features are automatically identified by the system and method of the present invention. FIG. 3A depicts a face having features that are associated with the element water. FIG. 3B depicts a face having features that are associated with the element fire. FIG. 3C depicts a face having features that are associated with the element earth. FIG. 3D depicts a face having features that are associated with the element air.

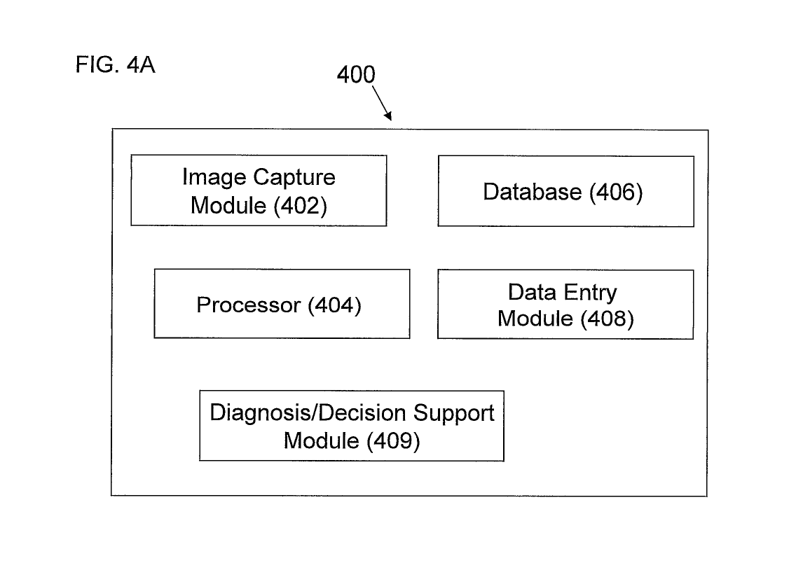

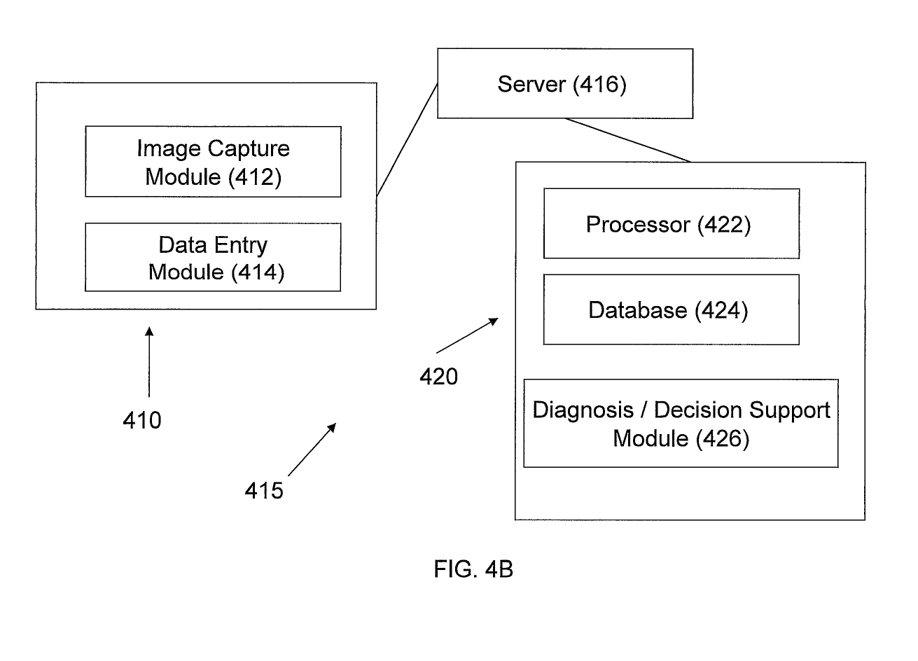

FIG. 4A depicts a block diagram of system 400 according to an optional embodiment of the present invention. System 400 comprises an image capture module 402, processor 404, database 406, data entry interface module 408 and diagnosis and decision support module 409. Preferably, image capture module 402 is used to capture an image of a face, for example with a video camera, still camera, or the like to capture a live facial picture. Image capture module 402 may optionally obtain a still image source for example including but not limited to a fax, photograph, scanned image, electronic image or the like.

Preferably, processor 404 processes the captured image to identify various features. For example, the features processor 404 may identify may optionally include but is not limited to elemental features such as earth, air, water and fire as depicted in FIG. 3A-D. Optionally, processor 404 may further identify facial features related to the sexual polarity of the captured image as described in FIG. 2A-C. Preferably processor 404 automatically identifies a set of features and parameters and scores them according to likelihood of belonging to a group. Optionally, processor 404 may identify features and parameters in a semi-automatic way, such that optionally at least one or more parameter is associated with a particular feature. Optionally, a user may determine which parameters best suit the feature in question using data entry module 408.

Preferably, once all features and parameters have been defined by processor 404, the human code associated with a captured image is defined by processor 404. Optionally, the captured image and its associated human code are both stored in database 406. Optionally, processor 404 may query database 406 during processing and analysis of the captured image.

Optionally and preferably, data entry module 408 may be used to enter manual data relating to an imaged captured with module 402 and processed by processor 404. Data entry may optionally and preferably include the results of a questionnaire, task solution, or input from external source or observations that may prove useful for the determination of the human code and or diagnosis. Processor 404 may then optionally determine the human code according to the manually entered data.

Preferably, once processor 404 abstracts a human code, a diagnosis and decision support module 409 optionally uses data queried from the database 406 to determine a diagnosis relative to the image captured with image capture module 402.

FIG. 4B depicts an optional embodiment of the system of the present invention as depicted in FIG. 4A. System 415 optionally comprises two sub systems, Data entry system 410 and Processing system 420, that are optionally and preferably connected over a network connection 416, for example including but not limited to the internet, intranet and using markup language or the like. System 415 depicts a further embodiment of the present invention wherein the data entry and image capture is accomplished via telemetric processing, such that the subject is at a remote location from processing system 420, for example using wireless, wired or cellular communication. Data entry system 410 comprises image capture module 412 and data entry interface 414. Image capture module 412 optionally includes but is not limited to a webcam, camera, scanner, facsimile, e-mail or any other messaging system for sending an electronic image, or any like source for obtaining a still or live image. An image captured with module 412 is then optionally communicated to processing system 420 using communication methods including but not limited to wireless, wired, optical, cellular telephone, internet or the like.

Processing system 420 comprises processor 422, database 424 and diagnosis and decision support module 426. Optionally, processor 422 extracts the features of the captured image to abstract the human code associated with it as described in FIG. 4A. Image processing may be further coupled to external data entered using data entry interface 414 that allows a user to enter further data for example including answers to a questionnaire, task performance results or further observations. Processing system 420 determines the human code corresponding to the captured image preferably abstracting an appropriate diagnosis using decision support module 426. Preferably, the captured image, human code and relevant data are stored in database 406.

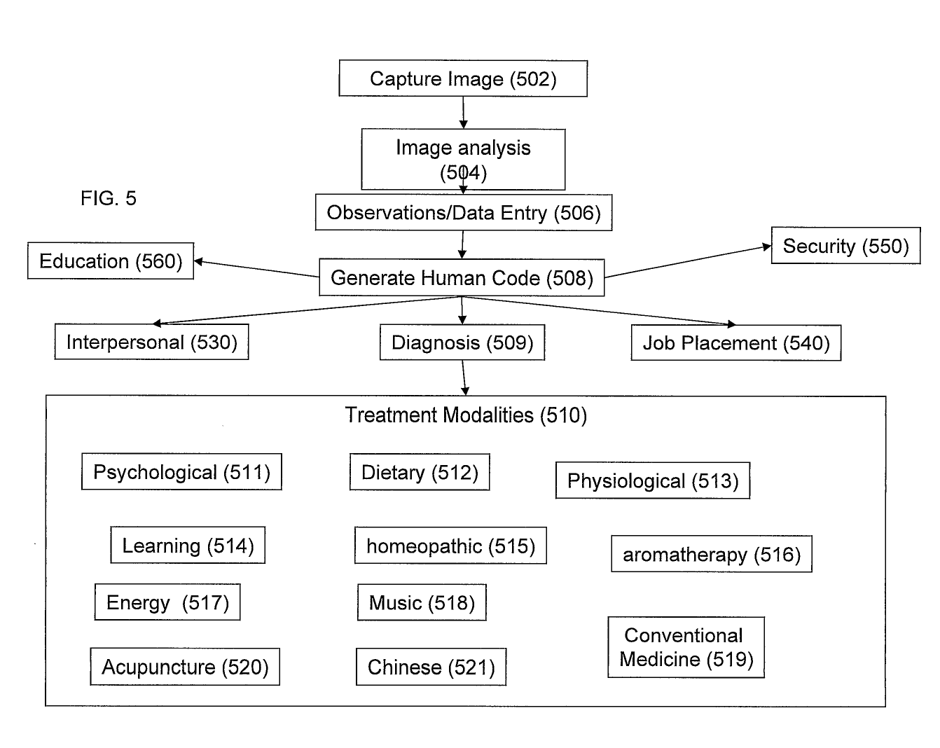

FIG. 5 shows a flowchart of an exemplary method according to the present invention of abstracting the human code and diagnosis relative to a captured image preferably of the face of an individual. In stage 502 an image is captured optionally the image capturing may be of a live image or a still image obtained by a webeam, live camera, a still picture, scanner, digital photograph or file or the like. Stage 504 provides for image processing an analysis where the image is analyzed to abstract at least one or more features and scoring the feature. For example, the polarity features illustrated in FIG. 2A-C are optionally and preferably examined and scored. Preferably further features are examined and scored to analyze the features of the captured image, for example the facial structure related to the four elements depicted in FIG. 3A-D. For example the parameters scored for particular features optionally include but are not limited to facial structure, forehead shape, hair color, hair texture, eye color, eye shape, nose shape, nose profile, teeth, chin, skin texture, eyebrows, ears, mouth and lips or the like. Optionally scoring may be accomplished by a comparison to a gold standard to determine relative membership to a particular parameter type of the elemental group. Optionally, once all features have been scored and identified, further observations optionally including but not limited to data entered manually based on a the subject's personal data, questionnaire, or task performance results, or further observation are entered in stage 506 to complete the processing of the captured image.

In stage 508 a human code is generated based on the captured image and observed data. Preferably the human code is then optionally utilized to produce an analysis optionally including but not limited to a medical diagnosis 509, interpersonal advice 530, job placement analysis 540, security analysis 550, educational analysis 560 or the like. Optionally, the human code may be converted to another code for example including but not limited to the universal code.

Optionally, in stage 509 a medical diagnosis is abstracted that is preferably derived based on the facial features and observations of the subject. Optionally and preferably the diagnosis is able to determine problem areas as well as healthy aspects of the subject, allowing a health care provider to determine what actions if any need to be taken. Optionally, once a diagnosis is abstracted in stage 510 optionally at least one or more treatment modalities are suggested from either traditional or conventional treatments for example including but not limited to energy treatments, music therapy, homeopathic, aromatherapy, physiologic treatment, psychological treatment, dietary treatment, Chinese medicine, acupuncture or the like. The selected treatment is preferably based on the diagnostic issues obtained through an analysis of the human code and may be in any one or a number of medical is fields.

The selection of one or more treatments is preferably performed according to an evaluation of the human code. For example, individuals having particular combinations of features, resulting in a particular code, may optionally and preferably receive certain treatments according to this code, for example to restore balance. Furthermore, if the diagnosis is accompanied by a plurality of questions regarding perceptions of the individual about him/herself, then any discrepancies between such answers and the human code may also optionally and preferably be used to select a treatment, more preferably in order to restore balance.

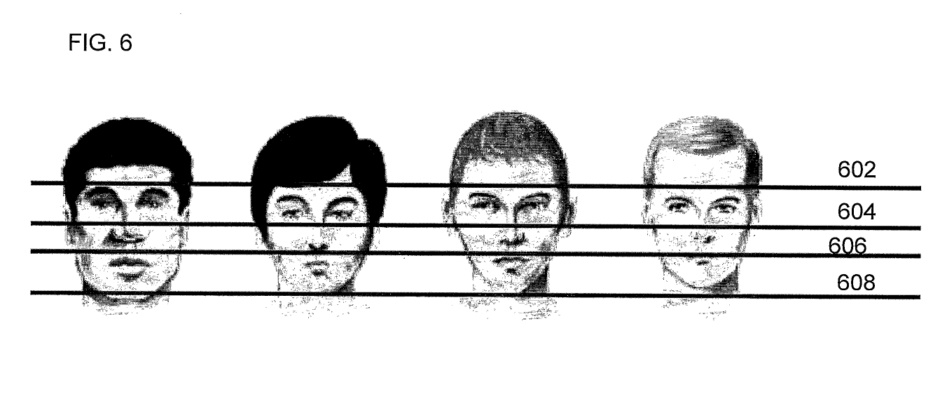

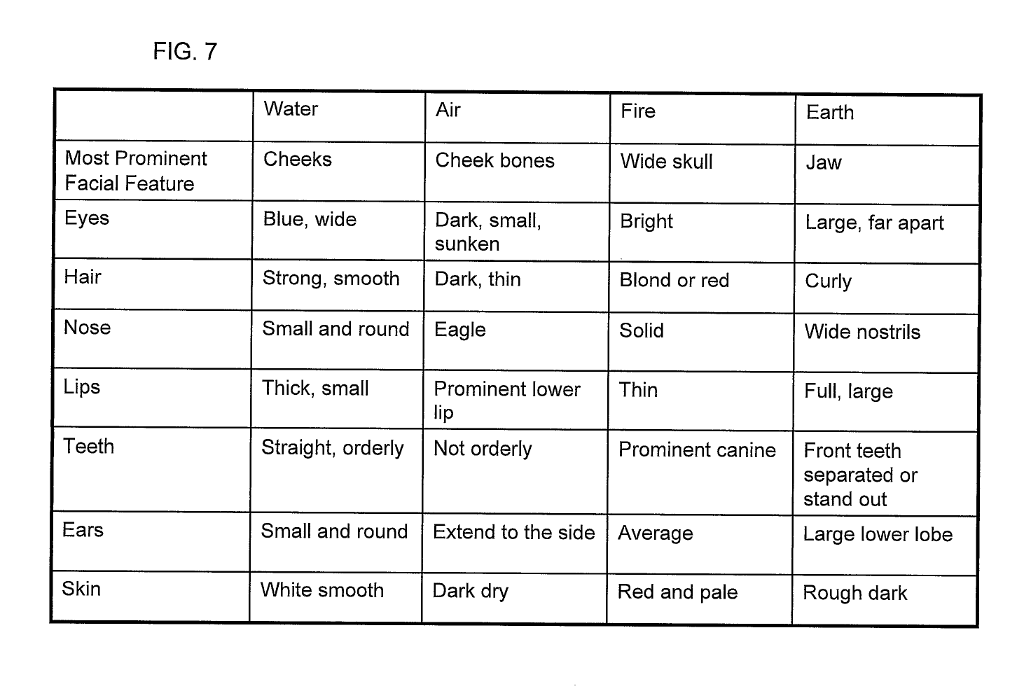

FIG. 6 is a diagram of an optional embodiment of the present invention showing how a captured image is processed according to an optional embodiment of the present invention. Optionally, the polarity of the captured image is determined based on the full image. Optionally a captured image is then broken into four facial regions: the brow 602, eyes 604, nose and cheek 606, and jaw and chin 608. Optionally each of the facial areas is scored according to their likelihood of belonging to a particular elemental group, depicted in FIG. 3A-D for example earth, air, water and fire. Each area may be independent of the other, optionally according to chart depicted in FIG. 7, showing an example of how each section may be evaluated in terms of the element group it belongs to. Optionally, parameters for example including but not limited to facial structure, forehead shape, hair color, hair texture, eye color, eye shape, nose shape, nose profile, teeth, chin, ears, skin texture, eyebrow, mouth and lips or the like are scored relative to their membership to a particular elemental group.

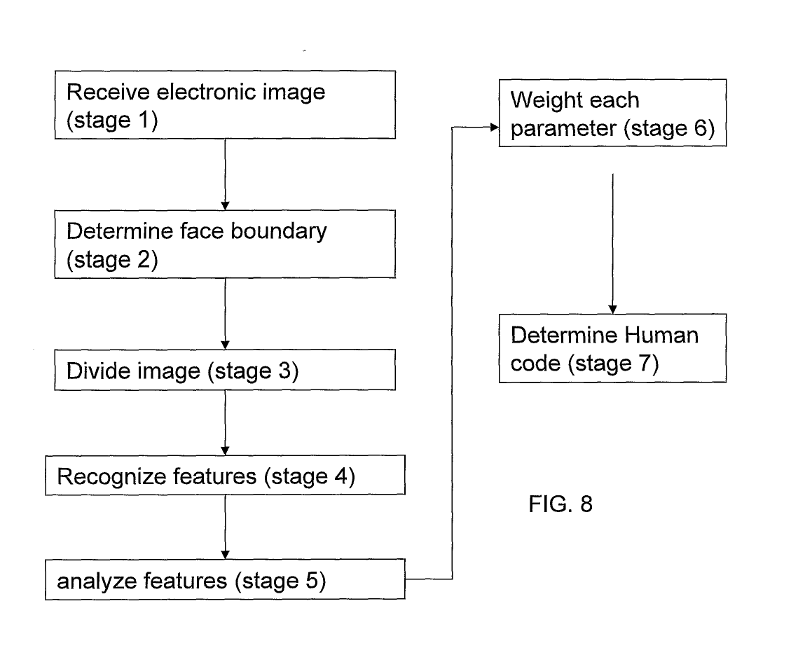

FIG. 8 is a flowchart of an exemplary method for image processing according to the present invention, which may optionally be used with any of the systems as described herein, and may also optionally be used with the implementation as shown in the diagram of FIG. 7. In stage 1, an electronic image is received for processing. The image preferably shows at least the face of a person, and optionally also shows other portion(s) of the body. The image may optionally be two or three dimensional.

In stage 2, the image is preferably analyzed to determine the boundary of the face. Various methods for determining a boundary are known in the art and could easily be implemented by one of ordinary skill in the art.

In stage 3, the portion of the image within the boundary is preferably divided into a plurality of sections for feature recognition. Image segmentation is also well known in the art and could easily be implemented by one of ordinary skill in the art. Additionally or alternatively, various transformations such as wavelet analysis may optionally be used (with or without image segmentation).

In stage 4, a plurality of features of the face are preferably recognized.

More preferably at least the features described in FIG. 6 are recognized. Again, such recognition could optionally be performed as is known in the art and/or as described in the above mentioned U.S. Pat. No. 6,301,370 and U.S. Pat. No. 6,947,579 as non-limiting examples only.

In stage 5, each feature is preferably analyzed for at least one parameter, again more preferably according to the description of FIG. 6. For example, the eyes may optionally and preferably be categorized by color (blue, brown, etc); size (small, large, wide); relative location (far apart, close together); and the quality of brightness. The relative amount or weight of each such parameter is preferably then determined in stage 6, in order to characterize each feature according to water, air, fire or earth, or a combination thereof.

In stage 7, the characterized feature information is preferably combined in order to determine the human code for the person whose face has been analyzed.

While the invention has been described with respect to a limited number of embodiments, it will be appreciated that many variations, modifications and other applications of the invention may be made.

1. A system for abstracting an individual's human code.

2. The system of claim 1 comprising an image capturing module for capturing an image of the individual; facial recognition software for analyzing said image to determine a plurality of parameters; and a processor for determining the human code from said plurality of parameters.

3. The system of claim 2 wherein said facial recognition software identifies facial regions and categorizes them according to predetermined characteristics.

4. The system of claim 3 wherein said predetermined characteristics are converted to said plurality of parameters for determining an individualized human code.

5. The system of claim 2 wherein said facial regions are chosen from the group consisting of the brow, eye, cheek and nose, jaw and chin.

6. The system of claim 1 adapted for diagnostic assessment.

7. The system of claim 1 adapted for personality assessment.

8. The system of claim 1 adapted for job assessment.

9. The system of claim 1 adapted for security assessment.

10. The system of claim 1 adapted for interpersonal assessment.

11. A method for abstracting an individual's human code comprising:
a. capturing an image of at least the face of the individual;
b. processing said image to determine a plurality of parameters of said image; and
c. abstracting the individual human code from said plurality of parameters.

12. The method of claim 11 further comprising:
d. providing additional observed data.

13. A method for diagnostic assessment, comprising:
a. determining the human code
b. abstracting diagnosis relative to the human code

14. method of claim 13 wherein the diagnosis is a dietary diagnosis.

15. The method of claim 12 wherein said decision support module selects at least one or more treatment modalities chosen from the group consisting of dietary, conventional medicine, traditional medicine, acupuncture, aromatherapy, music therapy, psychological, physiological, energy.

16. The system of claim 1 wherein personal parameters are used to abstract an individual's human code.

17. The system of claim 16 wherein said personal parameters comprise subject's name, subject's mother's name, a subject's date of birth.

18. The system of claim 1 adapted for educational assessment.

19. The system of claim 1 adapted for converting the human code to the universal code.
